(19) United States
(12) Patent Application Publication
(10) Pub. No.: US 2008/0209412 A1
(43) Pub. Date: Aug. 28, 2008

(54) Reselling Experienced Agents

(75) Inventors: Elmo Marcus Attila Diederiks, Eindhoven (NL); Albertus Josephus Nicolaas Van Breemen, Eindhoven (NL); Henriette Christine Marie Hoonhout, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,658

(22) PCT Filed: Jan. 30, 2006
(86) PCT No.: PCT/IB06/50313

§ 371 Date: Aug. 7, 2007

(30) Foreign Application Priority Data
Feb. 10, 2005 (EP) 05100952.0

(51) Int. Cl. G06F 9/44; G06F 15/16

(52) U.S. Cl. 717/172; 709/203

(57) ABSTRACT

The present invention relates to Assistant Software Modules (ASMs) providing services to users of e.g. a mobile phone. The ASMs are becoming learned (or skilled) by the user modifying the behaviour of the ASMs. Adding rules to a configuration file of the ASM preferably performs the modifications, but the modification may also be implemented as a neural network being trained. The invention relates in particular to management of the ASM, which management comprising uploading an ASM from a user who has modified the functionality of the ASM and downloading the ASM to a new user The uploading, downloading and terms for acquiring an ASM is regulated by rules prescribed by a manager of the ASMs.

### FIELD OF THE INVENTION

The invention relates to Assistant Software Modules (ASMs) providing services to users thereof and to management of the ASMs. The invention relates in particular to ASMs designed to be downloaded to and uploaded from electronic devices and rules for managing downloading, uploading and/or use of the ASMs.

### BACKGROUND OF THE INVENTION

WO 01/86985 discloses a system and a method for managing a mobile station wirelessly. The control software includes a dynamic agent operating programme and a group of objects linked to the dynamic agent operating programme. Some of the objects allow the mobile station to utilise services, such as accessing the Internet or E-mail services. Additional objects for providing access to new services may be wirelessly transmitted from a management server to the mobile station over the air and stored in the mobile station. Users may selectively delete and download objects to customise the services available through their mobile stations while minimising the memory requirements of the mobile station.

While such system and method allow the user to configure his mobile station with predefined services, customisation of the services is not possible and the management of the services is limited to downloading and deletions. Hence, improved customisation and management of Software Modules would be advantageous.

### SUMMARY OF THE INVENTION

The invention preferably seeks to provide methods and systems allowing easy customisation of functionality provided by software modules and methods and systems managing such software modules.

In a first aspect, the present invention relates to a method of managing Assistant Software Modules (ASMs). Preferably, the ASMs being adapted are to be distributed to and reside in a device and provide configurable functionality to the device upon an agreement made on the terms for acquiring an ASM between the provider of the ASMs and the user of the ASM. The method preferably comprising:
distributing a number of ASMs to users to provide them with the functionality of the ASMs,
receiving modified ASMs or at least a part thereof from at least some of said users, the modifications made to the ASMs are made by the users by configuring the configurable functionality, and
redistributing at least some of the modified ASMs to users.

By a method according to the first aspect of the present invention users of modified ASMs may benefit from functionality provided by other users.

In a preferred embodiment, the method may preferably further comprise the step of presenting to a user wanting to acquire an ASM, terms for the acquirement. Thereby, the user wanting to acquire an ASM may be able to compare the terms for one ASM with one or more other ASMs. The terms for the acquirement may preferably comprise one or more of the following conditions: price, ownership and uploading of the ASM or parts thereof to a receiver. In a particular preferred embodiment, the terms for a particular ASM reflect whether the ASM is a modified ASM, whereby it can be distinguished that one or more other users have modified a particular ASM.

The method may preferably further comprise the step of receiving feedback on the performance of a received modified ASM and preferably setting the terms for acquirement of the received modified ASM in accordance therewith. By such steps, the manager of the ASM will be given a direct measure on how well the ASM has performed and will be able to set the term for later acquirement of the ASM on the basis thereof. Typically and preferably, the feedback comprising receiving answers to a questionnaire, as such a way of receiving feedback may have the effect of providing rating of the performance of the ASM in a standardised form.

In a further preferred embodiment, the method preferably further comprises:
presenting a plurality of ASMs at least some of which are modified ASMs,
receiving input from a user representing a selection of a particular ASM from the plurality of ASMs,
accepting an agreement on the terms for acquiring the particular ASM selected, and in response thereto
installing the selected ASM on a device selected by the user.

Via these steps, a user may look through a plurality of ASMs in order to find the one which is most suited for meeting his needs and to install a selected ASM on his device once an agreement on the terms for acquiring has been set-up in an easy and user friendly manner.

Receiving a modified ASM or a part thereof by a method according to the present invention may preferably comprise the step of receiving from the user's device an ASM or a part thereof, assigning terms for acquiring the uploaded ASM and including it to the plurality of ASMs. Thereby easy redistribution of uploaded ASMs may by provided.

In a second aspect the present invention relates to a method of managing Assistant Software Modules (ASMs). Preferably, the ASMs being adapted are to be distributed to and reside in a device and provide configurable functionality to the device upon an agreement made on the terms for acquiring an ASM between the provider of the ASMs and the user of the ASM. The method preferably comprises:
installing an ASM on a device to provide the device with the functionality of the ASMs,
modifying the ASM or at least a part thereof to provide the ASM with configured functionality the modifications being made by the user by configuring the configurable functionality, and
uploading the modified ASM or at least a part thereof to an ASM managing system.

Hereby, the user may be able to adapt the functionality of an ASM to meet his own specific needs and other users may be able to benefit from his modification(s) in case the manager of the ASM managing system decides to redistribute the uploaded modified ASM.

The method may further comprise the step of accepting terms for the acquirement before installing the ASM on the device, and the terms for the acquirement may preferably comprise one or more of the following conditions: price, ownership and uploading of the ASM or parts thereof to the managing system. Thereby, the user may have a full overview of the terms for acquiring the ASM before such a transaction is performed. In a particular preferred embodiment, the terms for a particular ASM reflect whether the ASM has been modified by other users.

The method according to the second aspect may preferably further comprise the step of giving feedback on the performance of an uploaded modified ASM, and the feedback may in a particular embodiment comprise providing answers to a questionnaire. Thereby the user of the ASM may be able to give the provider of the ASM his view(s) on the performance of an ASM, and in case a questionnaire is used the feedback may be given in a standardised form.

The method may preferably further comprise:
selecting an ASM from a plurality of ASMs at least some of which are modified ASMs,
accepting an agreement on the terms for acquiring the ASM selected, and in response thereto
installing the selected ASM on a device selected by the user.

As indicated above in connection with the first aspect of the invention, a user may via these steps look through a plurality of ASMs, select the one most suited for his needs and install the selected one on his device in an easy manner.

In a third aspect the present invention relates to a configurable Assistant Software Module (ASM). Preferably, the ASM is provided with an instruction set, an interface enabling the ASM to co-operate with an operating system of a device, and an interface enabling the instruction set of the ASM to access one or more rules configuring the instruction set of the ASM, wherein at least some of the one or more rules are defined by a previous user of the ASM. By installing and executing such an ASM according to the third aspect of the present invention, the user may be able to configure and execute the instruction set which will provide a configured functionality to the device on which the ASM is installed.

In a fourth aspect, the present invention relates to a device comprising a processor and instructions for said processor, at least some of the instructions are provided by a configurable Assistant Software Module (ASM) having an interface enabling the instructions provided by the ASM to access one or more rules configuring at least the instructions provided by the ASM, wherein at least some of the one or more rules are defined by a previous user of the ASM. The functionality of such a device may have a functionality that may be adapted according to specific needs of the user of the device.

In a particular preferred embodiment, the device is preferably adapted to receive an ASM which either substitute one or more of the device's native instructions or add further instructions to the device. The ASM being preferably downloaded from a node in a network upon agreement on the terms for acquiring the ASM, which terms being preferably determined on the instructions comprised in the ASM.

In a fifth aspect, the present invention relates to a system for managing configurable Assistant Software Modules (ASMs) according to the present invention. Preferably, the system comprising a database (2) storing a plurality of ASMs at least some of which have been configured by one or more users having utilised the ASMs, a computer (3) adapted to handling uploading and downloading of ASMs between users and the database (2) and one or more network connections connecting the computer, database and users. The computer has preferably instructions enabling it to perform one or more of the steps of the method according to the first aspect of the present invention.

In a sixth aspect, the present invention relates to a memory or storage medium having programme instructions for carrying out the steps of the method according the first and/or second aspect of the present invention.

These and other aspects, features and advantages of the invention will be apparent from and elucidated with reference to the embodiments described hereinafter.

### BRIEF DESCRIPTION OF THE DRAWINGS

Embodiments of the invention will be described, by way of examples only, with reference to the drawings, in which

FIG. 1 is an illustration of a management system in accordance with the invention;

### DESCRIPTION OF PREFERRED EMBODIMENTS

The following description focuses on preferred embodiments of the invention applicable to e.g. portable devices. The preferred embodiments as disclosed comprising a number of managing rules, such as rules on pricing, terms for use etc. It should be emphasised that the embodiments and rules disclosed are examples on preferred embodiments and rules, and that the invention can be implemented in a numerous ways. In particular, it will be appreciated that the invention is not limited to this application, these embodiments and rules but may be applied in many other ways.

Preferred embodiments of the present invention relate to an Assistant Software Module (ASM). The ASM basically can be programmed or told or taught how to behave in certain situations or what actions to take in a certain context (much like a real-life secretary). In many situations, the ASM resides during use in some kind of portable device e.g. a cell-phone, and in such (and other) cases the behaviour of the ASM could be not to disturb one during a meeting, but rather to take and handle all incoming calls quietly, which could comprise handling the agenda or it might comprise setting up a list of people to be called back.

In a first preferred embodiment the invention relates to an ASM for a cell-phone. The ASM comprises a configurable functionality and a configuration file, so that an actual functionality of an ASM is determined by what is actually stored in the configuration file. In case the configuration file is empty, the default functionality will be that of the non-configured ASM, and in case the configuration file comprises some pre-defined rules the default functionality will be that corresponding to these rules.

The processor of the device and the instructions available for the device defines the functionality of a device. In accordance with preferred embodiments of the invention, an ASM comprises a number of further instructions for the processor and the configuration file comprising rules and/or data for configuring the instructions of the ASM. In this way, configurable instructions can be added to the device thereby providing a configured functionality to the device.

As an example, the ASM may comprise the default functionality to handle sending and receiving emails. In case the user wants to change the default functionality, rules and/or data can be added to the configuration file, thereby providing learning to the ASM. In this example, the user of the ASM can add a rule to the configuration file stating that upon receiving emails from one or more pre-defined email addresses an audio signal is initiated, while emails received from non pre-defined email addresses will effectuate only the default functionality of the ASM.

A similar approach can be followed when considering incoming phone calls. In this case, the learning of the ASM comprises that incoming calls from pre-selected persons are signalled by a special ring tone, and the learning is implemented as a rule assigning a special ring tone to pre-defined phone numbers while other incoming phone calls will not be effected by the learning of the ASM. Alternatively, the behaviour of the ASM can be to the take and handle all incoming calls quietly, which could comprise handling the agenda or it might comprise setting up a list of people to be called back.

In a further example, the ASM comprises a configurable meeting planner. The default functionality of the meeting planner is to check in a diary file whether a time period of a given length contains any meetings or in general any events. Adding rules to the configuration file can configure the meeting planner. One example on a rule is a rule to locate in the diary a period of say two hours for a meeting. The rule may be extended to include a specific time window, time needed for transportation, and/or look into other participants' diaries.

The ASM can also be configured to extract the present state of the cell-phone, the states may comprise, “normal”, “meeting”, “silent” etc and react according to rules set-up for these scenarios. For instance, the configuration file can comprise a rule saying that in case the state is “meeting” and a rejection is the input in response to an incoming call, then the length of the meeting is deduced from the device's diary and informed back to the party calling.

The ASM is designed to interact with the functionality of the device the ASM resides in during use. The interaction between the functionality of the device and the ASM is such that the device is fully workable in its default mode, i.e. when the ASM is not activated or installed, so that the ASM may be downloaded to and uploaded from the device while leaving the device workable.

In the mobile phone example at least two scenarios exist: 1: the operating system or programme is a monolithic operating programme including routines for e.g. handling mails, calls, volume control etc. and 2: a dynamic operating programme interacting with “plug-ins” for handling emails, calls, volume control etc.

In a preferred embodiment of the ASM, the ASM furthermore comprises a monitoring functionality which may have the ability to interact with a remote management system. This monitoring functionality comprises monitoring the content of the configuration file, the workload of the ASM and/or transceiving messages between a node in a network and the device. In preferred embodiments, the messages comprise reports on the use of the ASM, the number of rules in the configuration file, and/or the workload of the ASM.

The monitoring function can be intelligent in the sense that it is designed to adapt the functionality of the ASM to the behavioural pattern of the user of the ASM. The intelligence is in the form of a neural network that receives its training by tracking the input to the ASM by the user.

In a further example, an adaptation software module resides—or is to reside—in the device in which the ASM is—or is to be—installed. The adaptation software module is designed to change the rules of the ASM in a manner taking into account the implicit feedback of a user, and/or explicit feedback of a user, preferably in a completely automatic manner or by specific interaction with the user. Such an adaptation software module may provide a smooth interfacing between the ASM and user when modifying the functionality of the ASM. The adaptation software module may be provide as a part being build into the ASM but may also be a separate module, preferably downloaded in a manner as the ASM.

An ASM according to the present invention is implemented as a plug-in for substituting a given functionality of, if present, or to add a functionality to the operating programme.

An ASM according to the present invention is typically downloaded from a node in a network, such as an Internet web site. Upon downloading a contract is made between the recipient and the provider and the price for the ASM is determined according to one or more business rules. For instance, if an ASM is to be downloaded with an empty configuration file, the price is typically lower than if the ASM is purchased with a configuration file comprising a number of rules. Furthermore, the more rules the configuration file comprises the higher the price.

All the learning of the ASMs can as a general measure be stored in the ASM's configuration file. In case the learning is in the form of training a neural network, data for this network is stored in the configuration file. This obviously increases the value of this particular instant of the ASM, but it does not need to imply that hiring it becomes more expensive for the user that taught it all this (but it could be). A basic idea is that, like in real life, the ASM becomes more expensive for other people to hire. Other users may be willing to pay more for a particular instants of an ASM, and in that case the ASM or the manager of the ASM might consider to work for another user, unless the current user decides to pay more for the ASM for instance of the contract ends, for example after 1 year. In such a way the ASM can gather information from multiple users and draw general conclusions from that as well as this information can be used by the ASM manager to build new and better ASMs.

In general, the user may choose to either purchase or rent the ASM for a given period of time. In case the ASM is rented, the price for renting will typically comprise a fixed fee covering the rent for the default functionality and a varying fee depending on the learning of the ASM, this typically being priced based on the number of rules comprised in the configuration file. Once the ASM is installed in the device, the monitoring functionality, if present, may be activated and reports may be sent to the provider of the ASM. In case it is detected that rules are added to the configuration file, the user could be informed that the rent fee is increased, if desired, and if accepted by the user, the billing will be effectuated accordingly.

If the user decides not to use the ASM anymore, the ASM or at least its configuration file is transmitted to the provider of the ASM and the ASM is deleted from the device. The ASM and/or its configuration file is upon receipt cleaned in order to remove any personal information, and this configuration file may then be sold or rented to other users. The user may be given a “success fee” for allowing later use of his ASM and/or configuration file in an anonymous form.

In general, uploading of an ASM being used by user is preferred irrespective of whether the user has purchased or rented the ASM. When such an upload has been received for instance by a manager, the rules added to the configuration file has resulted in a modified ASM, at least as viewed by the manager, and the modified ASM is then offered for rent or purchasing.

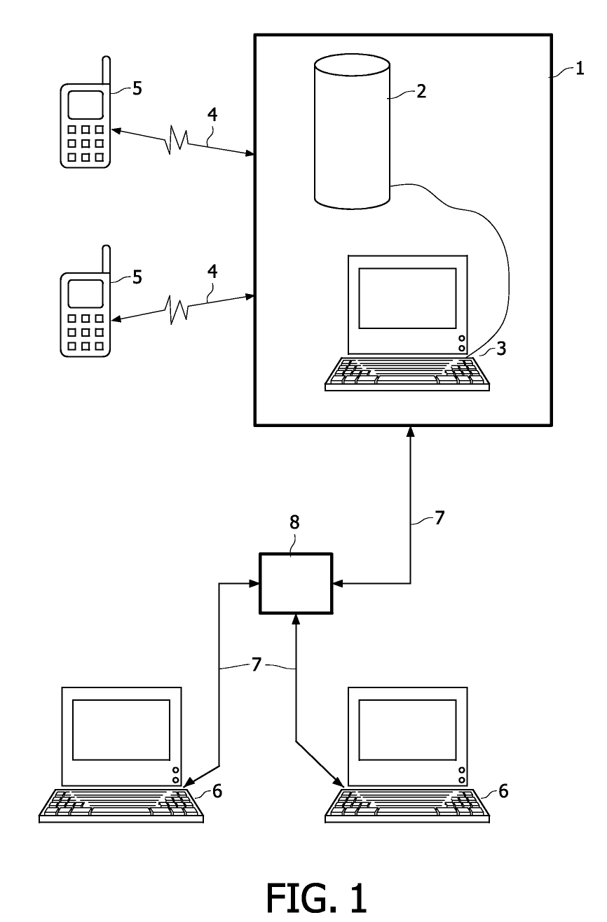

FIG. 1 indicates management of ASMs. The management of ASMs is performed by a management system comprising computer system 1, having a database 2 storing a plurality of ASMs at least some of which have gained learning by been used previously. The computer system 1 further comprising a computer 3 that handles the interfacing with the customers and the functionality needed in order to provide the management of the ASM. The computer system 1 is connected—or connectable—with a number of wireless devices, such as mobile phones 5 via wireless connections 4. The computer system 1 is furthermore connected—or connectable—to a number of computers 6 via network connections 7 comprising one or more routers 8. This network is preferably the Internet network.

The learning of the ASMs is manifested as feedback on their functionality to the computer system 1 typically as disclosed by users. To each of the ASMs a price tag is provided indicating the price for a given ASM, which price depends on the experience of the ASM evaluated on the basis of the feedback.

A user wanting to acquire an ASM access the computer system 1 and is presented to the plurality of ASMs and their corresponding prices. Furthermore, the user may be presented to a more overall description of the learning of each ASM as disclosed by previous users of the ASMs.

The price for an ASM may be established in a number ways. For instance a person may assess the feedback a given ASM has been given and fix the price on this assessment. However, it is preferred that feedback is given by filling in a form comprising a selectable predefined rating, typically ranging from 0 to 10 where 0 means not acceptable and 10 means perfect. Based on the rating provided the system will set the price for the ASM which will then be offered for sale or rent again. The price is determined typically as an overall rating derived from the form times a maximum price fixed by the provider of the ASM, e.g. overall rating=9, maximum price=100 resulting in a price of 9*100=900.

In a further example, multiple users have been using the same ASM and could each provide a rating on the use of the ASM. The resulting rating can be a (weighted) average of these ratings. The price of an ASM can then be made depended on this rating. Another measure that may be taken into consideration when pricing an ASM, either alone or in combination with other measures such as rating, could be the years of experience the ASM has and also if it has had experience with multiple users. As an example, the previous users could provide information on their job so that the ASM price depends on whom they have been working for. For instance, a CEO or a cleaning lady can both use an ASM, but obviously the ASM will be taught different skills/rules and consequently the price can vary accordingly.

As an example: in case the rating is 0 the ASM is allowed to “come in play” for a minimum price (or if desired for free). However, the user is only allowed to use the ASM for an evaluating period and if the rating is still 0 after the evaluating period, the user is not allowed to use the ASM in question anymore.

When a user has decided on a particular ASM the terms for the procurement is to be settled. The user may select either to hire the ASM on a renting basis or to purchase the ASM. In case the user selects to rent the ASM the user is stimulated to provide his feedback and upload a copy of the ASM or its configuration file to the management system by offering a discount for doing so. The copying of the ASM—or at least the ASM's configuration file—is a neat way for the manager of the management system to be able to benefit from any changes made to the ASM by the user.

In case the user selects to purchase the ASM, the user is stimulated to upload the current version of the ASM, or at least the configuration file, to the computer system 1, typically on a regular basis. The stimulation is in the form of a fee or other reward.

Once an owner or a hirer uploads a version of an ASM or its configuration file to the manager, the uploaded version can be offered for sale or hire. The price for purchasing or hiring the uploaded version may in some cases be set higher than its original price and if the uploaded version is purchased or hired the ASM is said to have been assigned to a new job. In a special scenario, the user who has uploaded the ASM is notified that the contract on the use of the ASM is terminated.

As disclosed above, the ASMs may be provided with a monitoring functionality. In this case, the contract made between the user of an ASM in question and the manager of the management system comprises a price of the ASM reflecting the actual use of the ASM. For instance, the pricing may be depending on the number of operations performed by the ASM for the user and the functionality added to the ASM. The user will be stimulated to share the functionality he has developed by being rewarded a fee for uploading such information to the computer system 1.

A user may not be allowed to acquire the same ASM more than one time in order to avoid fraud. In the other case, a user may acquire an ASM for short period and give it a 0 rating whereafter he can have the very same ASM for free. Therefore, each instant of the ASM is preferably given a unique ID that distinguishes two ASMs from each other.

In order for the manager to control Intellectual Property Rights management, the contract made between the person wanting to hire or purchase an ASM the contract will include a clause regulating the rights to any copyrights or other rights, the person may have or gain in the ASM.

A user may obtain an ASM in a number of ways for instance by the method discloses in connection with FIG. 1. As a further example ASMs could be provided by a telephone service offered through a telephone network, e.g. GSM, GPRS, UMTS. As an example, the device may connect to the telephone service by one of the aforementioned standards or similar standard with a request to purchase an ASM and the telephone service may download the purchased ASM over the telephone network. The ASM is preferably uploaded in the same manner.

In a even further example, the ASM is provided by a computer and/or Internet service where the ASM can be downloadable via a personal computer to portable device for instance a PDA/agenda kind of device. Also in this example, uploading is preferably done in the same manner.

Is it envisaged, that the different examples on ways to download, upload, giving feedback etc. may be combined in one management system, e.g. be included in the management system of FIG. 1.

The above description of preferred embodiments and examples has focussed on services provided by the ASMs' own functionality. However, the ASMs could also be configured to utilise a telephone service offered through a telephone network (e.g. GSM. GPRS, UMTS). For example, a mobile phone having an ASM installed could redirect incoming phone calls to an external service e.g. a call centre, a receptionist and/or other service provider. The service provided by an ASM can also be a computer/internet service where the ASM can be downloadable via a PC to a portable device (for instance for PDA/agenda kind of devices).

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a singly unit or may be physically and functionally distributed between different units and processors.

Although the present invention has been described in connection with the preferred embodiments, it is not intended to be limited to the specific form set forth herein. Rather, the scope of the invention is limited only by the accompanying claims. In the claims, the term comprising does not exclude the presence of other elements or steps. Furthermore, although individually listed, a plurality of means, elements or method steps may be implemented by e.g. a singly unit or processor. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs in the claims are provided merely as a clarifying example and shall not be constructed as limiting the scope of the claims in any way.

1. A method of managing Assistant Software Modules (ASMs), said ASMs being adapted to be distributed to and reside in a device and provide configurable functionality to the device upon an agreement made on the terms for acquiring an ASM between the provider of the ASMs and the user of the ASM, the method comprising:
distributing a number ASMs to users to provide them with the functionality of the ASMs
receiving modified ASMs or at least a part thereof from at least some of said users, the modifications made to the ASMs are made by the users by configuring the configurable functionality, and
redistributing at least some of the modified ASMs to users.

2. A method according to claim 1, further comprising the step of presenting to a user wanting to acquire an ASM terms for the acquirement.

3. A method according to claim 2, wherein the terms for the acquirement comprising one or more of the following conditions: price, ownership and uploading of the ASM or parts thereof to a receiver.

4. A method according to claim 3, wherein the terms for a particular ASM reflect whether the ASM is a modified ASM.

5. A method according to claim 1, further comprising the step of receiving feedback on the performance of a received modified ASM and setting the terms for acquirement of the received modified ASM in accordance therewith.

6. A method according to claim 5, wherein the feedback comprising receiving answers to a questionnaire.

7. A method according to claim 1, further comprising:
presenting a plurality of ASMs at least some of which are modified ASMs,
receiving input from a user representing a selection of a particular ASM from the plurality of ASMs,
accepting an agreement on the terms for acquiring the particular ASM selected, and in response thereto
installing the selected ASM on a device selected by the user.

8. A method according to claim 7, wherein receiving modified ASM or a part thereof comprising the step of receiving from the user's device an ASM or a part thereof, assigning terms for acquiring the uploaded ASM and including it to the plurality of ASMs.

9. A method of managing Assistant Software Modules (ASMs), said ASMs being adapted to be distributed to and reside in a device and provide configurable functionality to the device upon an agreement made on the terms for acquiring an ASM between the provider of the ASMs and the user of the ASM, the method comprising:
installing an ASM on a device to provide the device with the functionality of the ASMs,
modifying the ASM or at least a part thereof to provide the ASM with configured functionality the modifications being made by the user by configuring the configurable functionality, and
uploading the modified ASM or at least a part thereof to an ASM managing system.

10. A method according to claim 9, further comprising the step of accepting terms for the acquirement before installing the ASM on the device.

11. A method according to claim 10, wherein the terms for the acquirement comprising one or more of the following conditions: price, ownership and uploading of the ASM or parts thereof to the managing system.

12. A method according to claim 11, wherein the terms for a particular ASM reflect whether the ASM has been modified by other users.

13. A method according to claim 9, further comprising the step of giving feedback on the performance of an uploaded modified ASM.

14. A method according to claim 13, wherein the feedback comprising providing answers to a questionnaire.

15. A method according to claim 9, further comprising:
selecting an ASM from a plurality of ASMs at least some of which are modified ASMs,
accepting an agreement on the terms for acquiring the ASM selected, and in response thereto
installing the selected ASM on a device selected by the user.

16. A configurable Assistant Software Module (ASM), said ASM being provided with an instruction set, an interface enabling the ASM to co-operate with an operating system of a device and an interface enabling the instruction set of the ASM to access one or more rules configuring the instruction set of the ASM, wherein at least some of the one or more rules being defined by a previous user of the ASM.

17. A device comprising a processor and instructions for said processor, at least some of the instructions are provided by a configurable Software Module (ASM) having an interface enabling the instructions provided by the ASM to access one or more rules configuring at least the instructions provided by the ASM, wherein at least some of the one or more rules being defined by a previous user of the ASM.

18. A device according to claim 18, said device being adapted to receive an ASM which either substitute one or more of the device's native instructions or add further instructions to the device, the ASM being downloaded from a node in a network upon agreement on the terms for acquiring the ASM, which terms being determined on the instructions comprised in the ASM.

19. A system for managing configurable Assistant Software Modules (ASMs), the system comprising a database (2) storing a plurality of ASMs at least some of which have been configured by one or more users having utilised the ASMs, a computer (3) adapted to handling uploading and downloading of ASM between users and the database (2) and one or more network connections connecting the computer, database and users, said computer having instructions enabling it to perform one or more of the steps according to claim 1.

20. A memory or storage medium having programme instructions for carrying out the steps of the method as claimed in claim 1.
